(19) United States
(12) Patent Application Publication
(10) Pub. No.: US 2025/0189165 A1
(43) Pub. Date: Jun. 12, 2025

(54) AIR-DUCTING COMPONENT WITH SPREAD TOW FABRIC, METHOD FOR PRODUCING A COMPONENT AND METHOD OF USING A SPREAD TOW FABRIC IN A COMPONENT AND/OR A METHOD

(71) Applicant: Diehl Aviation Laupheim GmbH, Laupheim (DE)

(72) Inventors: Andre Pfetscher, Ulm (DE); Robert Bein, Laupheim (DE)

(21) Appl. No.: 19/058,066

(22) Filed: Feb. 20, 2025

Related U.S. Application Data
(63) Continuation of application No. PCT/EP2023/079552, filed on Oct. 24, 2023.

(30) Foreign Application Priority Data
Oct. 28, 2022 (DE) 10 2022 128 601.0

(51) Int. Cl. F24F 13/02; B29C 70/00; B29C 70/22; B29K 63/00; B29K 105/08; B29L 23/00

(52) U.S. Cl. CPC F24F 13/0281; B29C 70/003; B29C 70/222; B29K 2063/00; B29K 2105/0872; B29L 2023/22

(57) ABSTRACT

An air-ducting component includes a wall which provides an airtight delimitation for an interior space from an exterior space surrounding the component. The wall includes at least a first layer of a prepreg material extending as a surface. The prepreg material includes a fabric extending as a surface and being impregnated with a resin composition. In at least the first layer, the fabric is a spread tow fabric, which contains respective spread tapes of fibers. The tapes are woven together in a weave. A method for producing the component includes integrating the spread tow fabric as the fabric into the wall in at least the first layer. The spread tow fabric is used in the component and/or the method.

### CROSS-REFERENCE TO RELATED APPLICATION

This application is a continuation, under 35 U.S.C. § 120, of copending International Patent Application PCT/EP2023/079552, filed Oct. 24, 2023, which designated the United States; this application also claims the priority, under 35 U.S.C. § 119, of German Patent Application DE 10 2022 128 601.0, filed Oct. 28, 2022; the prior applications are herewith incorporated by reference in their entirety.

### FIELD AND BACKGROUND OF THE INVENTION

The invention relates to a component which is configured for ducting air in an air-conditioning system on a passenger aircraft. In other words, it is an air-ducting component which, as part of the air-conditioning system in the aircraft, carries air, e.g. to the passengers/the passenger cabin, or carries it away from there. The invention also relates to a method for producing a component and a method of using a spread tow fabric in a component and/or a method.

It is known from practical experience that such air-ducting components can be produced with a wall which includes one or more layers of prepreg materials. After curing, the finished air-ducting components can then be coated with a sealing varnish in order to achieve adequate leak-tightness of the wall with respect to leakage or passage of air through the wall. In that case, the required maximum allowed leakage value is, in particular, 3 liters of air per minute and per square meter.

### SUMMARY OF THE INVENTION

It is accordingly an object of the invention to provide an improved air-ducting component with a spread tow fabric, a method for producing a component and a method of using a spread tow fabric in a component and/or a method, which overcome the hereinafore-mentioned disadvantages of the heretofore-known components and methods of this general type.

With the foregoing and other objects in view there is provided, in accordance with the invention, a component configured for ducting air in an air-conditioning system on a passenger aircraft.

The component includes an interior space. The interior space ducts the air during operation of the component, that is to say, therefore, is configured for corresponding air ducting.

The component includes a wall. The wall provides an airtight delimitation for the interior space with respect to an exterior space surrounding the component. In this context, “airtight” should be interpreted to mean that a permissible leakage value/leak rate/leakage rate is not exceeded. This expresses how much air per unit of time flows/diffuses through the wall. For example, the limit may be a maximum of 3 liters of air per minute and per square meter. The wall does not fully delimit the interior space since at least two openings, namely at least one inlet and at least one outlet for air to flow through the interior space and through the component formed by the wall must remain open.

The wall includes at least a first layer of a prepreg material extending in the form of a surface. As an option, further layers of prepreg material in the wall are possible. In other words, this is therefore a laminar/sheet-like/flat prepreg material.

The prepreg material includes a fabric which extends in the form of a surface in a corresponding manner. The fabric is impregnated with a resin composition. Strictly speaking, “impregnated” describes, in particular, a prefabrication or manufacturing state of the prepreg material, in this case of a semifinished prepreg. In the fully manufactured component, the prepreg material is then processed in the manner conventional in the art, e.g. by thermal treatment/curing of the resin composition etc. Even then, however, the fabric is still impregnated by (cured) resin or embedded therein.

In at least the first layer, the fabric is a spread tow fabric. The corresponding fabric includes respective spread tow tapes made of fibers. This means that the tapes in turn are formed by a plurality of fibers disposed in parallel in a plane. This arrangement of the fibers is achieved, in particular, by a process of combing a bundle of fibers (tow). The tapes have a plurality of (at least two) opposite flat sides and, in particular, have an almost rectangular cross section. In other words, a fiber bundle is first of all formed from a plurality of fibers, and the fibers are aligned in such a way by using a combing process that a tape is produced or formed.

The tapes are woven together in a weave. A weave is interpreted to mean the system of crossovers of the individual tapes. The crossovers, which are produced by using a weaving process, are, in particular, at right angles. This means that the interwoven tapes are disposed at right angles to one another and in this way form the fabric.

Preferred or advantageous embodiments of the invention and other categories of invention can be found in the other claims, the following description and the appended figures.

A corresponding spread tow fabric (Spread-Tow-Fabric Strap) is known, for example, from “Spread tow fabric,” and is found on Wikipedia, in the website https://en.wikipedia.org/wiki/Spread_tow_fabric, accessed on 05.10.2022 or as products called “TeXtreme (R)” by Oxeon AB, Oxeon AB, Foretagsgatan 24, 504 64 Boras, SWEDEN, see, for example, the website https://www.textreme.com/products-services/spread-tow-products/accessed on Jun. 10, 2022. In the case of a fabric of that kind, the fibers are, in particular, first of all combed and spread to a certain width before the weaving process. The spread tow tapes are further processed to give fabrics and then prepregs. In that way, “spread tows” are formed. Due to the large width of the tapes in relation to a round/oval yarn, the fabric manufactured therefrom has fibers which are significantly less wavy and it has fewer crossing points.

According to the invention, the avoidance of sealing varnish on air-ducting components is achieved by the use of prepregs reinforced with spread tow fabric.

In order to produce air-ducting components, use is accordingly made of a prepreg which is formed of a resin system and a special reinforcing fabric, namely a spread tow fabric.

The invention is based on the following insight:

The (reinforcing) fabric of the prepregs which was heretofore used for such components, with the fabric extending in the form of a surface, had a defined crossover of the tapes (weave). At each crossing point, the tapes must avoid one another by undulating, as a result of which they are locally oriented in the thickness direction, that is to say transversely/obliquely with respect to their flat surface of extent. Due to the cross-linking reaction of the resin (resin composition) during curing, microchannels are formed within the prepreg. Due to the alignment of the tapes at the crossing points, the channels can also run through the entire layered structure, that is to say can extend from the interior space to the exterior space. The air-ducting components that are conventional in practice are manufactured from glass fiber and/or carbon fiber prepregs. Due to the weave used, the tapes in the reinforcing fabric have a high degree of waviness, referred to as undulation. In the case of air-ducting components, air can pass through the wall from the interior space to the exterior space via the microchannels at the crossing points. This compromises the leak-tightness of the component or the wall to the extent that the required leakage value of, for example, 3 l/min/m² can be achieved only by subsequent coating of the wall or component with a sealing varnish.

The invention is based on the insight that, due to the large width of the tapes in spread tow fabrics, fabric manufactured therefrom has fibers which are significantly less wavy and has fewer crossing points. In particular, the use of two spread-tow prepreg layers lying flat one above the other makes it possible to achieve the required leak-tightness of air-ducting components in a particularly simple manner.

The invention is also based on the insight that the components currently produced in practice—in particular by low-pressure hose technology (see, for example, German Patent Application DE 10 2012 013 289 A1 or German Patent Application DE 10 2016 013 115 A1)—must be coated with sealing varnish after curing in order to achieve the required airtightness. The sealing varnish leads to poorer fire resistance properties and additional costs for material, weight and process times.

According to the invention, a reduction in weight in the double-figure percentage range compared with a structure known in practice is possible by virtue of the material “spread tow fabric” and/or the omission of the no longer required sealing varnish. According to the invention, the production of air-ducting components with sufficient leak-tightness succeeds thanks to the prepreg reinforced with spread tow fabric. The subsequent application of sealing varnish to air-ducting components is thereby avoided.

For the air-ducting components, use is made, in particular, of prepregs that are formed of or contain a special resin (see below: resin composition according to International Publication WO 2019/034280 A1) and the special fabric, namely the spread tow fabric. In particular, however, the component can also be produced with a different resin, particularly if it is a polyaddition resin.

In particular, the use of two spread-tow prepreg layers lying one above the other makes it possible to achieve the required leak-tightness of air-ducting components without the use of additional sealing varnish.

According to the invention, the processing of spread tow fabric with a resin system, in particular a flame-protected resin system, gives a semifinished prepreg suitable for aeronautical applications which achieves the required leak-tightness of air-ducting components, in particular even with just two superimposed layers.

In this case, the term “passenger aircraft” should be interpreted broadly, and also includes UAM (urban air mobility) aircraft, for example.

The width of the tapes in the spread tow fabric is, in particular, greater than 1 cm, in particular greater than 2 cm. The grammage of the spread tow fabric is, in particular, between 50 g/m² and 200 g/m², e.g. 160 g/m², fabric grammage.

In a preferred embodiment, at least one, in particular a plurality of, in particular all of, the tapes have a ratio of the width thereof to a height thereof of at least 100 to 1 (100/1) in cross section. In this case, the cross section is oriented transversely to the direction of the longitudinal extent of the tape. In particular, the ratio is at least 200 to 1 or at least 250 to 1. A particularly dense and also flat fabric can thereby be created.

In a preferred embodiment, the tapes are woven at right angles to one another in the weave. A corresponding fabric can then be produced in a particularly simple manner.

In a preferred variant of this embodiment, the weave is a linen weave. This weave too is particularly simple to produce.

In a preferred embodiment, the spread tow fabric has at least one, in particular a multiplicity of, gap points. The wall includes at least one, in particular also a plurality of, coverings. The covering covers at least one, in particular also a plurality of, or all of, the respective gap points. Such a gap point is a gap in the fabric in the sense that the fabric is weaker and less dense there than at other locations. The gap point is therefore a point or region in which fewer or no fibers of a tape or, at most, a tape is present perpendicularly to the surface of extent of the fabric. At a gap point, microchannel formation perpendicularly to the wall in the resin composition during its curing is possible, or there is increased probability thereof, and this increases air permeability in this region. Due to the covering of the gap point by the covering, the corresponding “gap” in the layer/the fabric is closed, thus ensuring that, there too, microchannel formation is prevented or mitigated, or the probability thereof is reduced. The airtightness of the wall is thereby improved.

In a preferred variant of this embodiment, at least one of the gap points is a crossing point of respective lateral edges of two mutually crossing tapes. In this case, “side” again refers to the surface of extent of the fabric. Such a gap point forms, for example, in the center of four mutually crossing tapes, wherein in each case two of the tapes are parallel to one another and, ideally, directly adjacent. Even with this configuration, there may be space for a through channel in the center of the crossing region since the tapes may not rest against one another in an absolutely leak-tight manner. Particularly in the case of a linen weave, such completely leak-tight contact may be simply impossible due to the necessary crossovers. Sealing by a covering is therefore particularly effective at appropriate locations.

In a preferred variant of this embodiment, the covering jointly covers at least two, in particular more than two, in particular all of, the gap points of the first layer. In particular, therefore, a plurality of or all of the gap points of the first layer are jointly covered by the covering. In this way, a particularly leak-tight wall (fabric with sealing measures) is achieved.

In a preferred variant of this embodiment, the covering is a further prepreg material. This can be applied, in particular, in the manner of local “patches”, e.g. one patch per gap point, in order to cover it in each case. In particular, however, it may also be a complete layer, see below.

In a preferred variant of this embodiment, the further prepreg material likewise includes a spread tow fabric. A particularly leak-tight wall can thereby be achieved. Two superimposed layers of spread tow fabric are sufficient in practice to meet even strict requirements on airtightness, as already mentioned above.

In a preferred embodiment, the covering is a further layer of the further prepreg material, that layer completely covering the first layer. Particularly in the case of identical fabrics in both layers, it is then really necessary to ensure, in particular, that the respective gap points of both layers do not lie congruently one on top of the other. In practice, this can be achieved easily by a corresponding offset and it leads to particularly high leak-tightness.

In a preferred embodiment, the wall has a leakage/leak rate/leakage rate of air between the interior space and the exterior space of at most 3 l/min/m², in particular at most 1.5 l/min/m², at a pressure difference of 40 mbar between the interior space and the exterior space. Even particularly strict leak-tightness requirements on air-ducting components are thereby met.

In a preferred embodiment, the resin composition is one for a prepreg resin, including:—a phosphorus-modified epoxy resin,—a further epoxy resin component,—a curing agent,—an imidazolium salt as an initiator, wherein the resin composition includes 2 to 5 percent by weight of a reactive diluent to accelerate the curing of the phosphorus-modified epoxy resin.

A resin composition of this kind is one according to International Publication WO 2019/034280 A1, published Feb. 21, 2019, corresponding to International Application PCT/EP2018/000393, of the Applicant Diehl Aviation Laupheim GmbH of the instant application, to which reference is made herein. The following technical features of the document to which reference is made should be taken to belong to the teaching of the invention: the resin composition and the method for the production thereof as well as the prepreg material including a fiber material which is impregnated with the resin composition. To this extent, the document is incorporated by reference into the disclosure of the invention. In other words, the component under consideration can be produced or have been produced using this resin composition.

With the objects of the invention in view, there is also provided a method for the production of a component according to the invention. In the method, the spread tow fabric is integrated as fabric into the wall in at least the first layer. Integration is accomplished, in particular, by baking in, in particular as per the low-pressure hose construction method/low-pressure hose technology, as already mentioned above.

The method and at least some of the possible embodiments thereof as well as the respective advantages have already been explained analogously in conjunction with the component according to the invention.

In one preferred embodiment of the method in conjunction with the abovementioned embodiment, relating to the gap points, at least one of the gap points is covered with the covering, wherein the covering is integrated into the wall. In particular, in this case the covering is impregnated with the resin composition of the first layer and/or surrounded by it. In particular, in the context of manufacture, a further spread tow fabric is placed as a covering on the first layer of the fabric. This gives rise to a particularly leak-tight air-ducting component.

With the objects of the invention in view, there is concomitantly provided a method of using a spread tow fabric in the component according to the invention or in the method according to the invention.

Other features which are considered as characteristic for the invention are set forth in the appended claims.

Although the invention is illustrated and described herein as embodied in an air-ducting component with a spread tow fabric, a method for producing a component and a method of using a spread tow fabric in a component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a highly-diagrammatic, perspective view of an air-ducting component according to the invention;

FIG. 2 is a fragmentary, enlarged, perspective view of a segment Il of FIG. 1; and

FIG. 3 is a plan view of two fabric layers of FIG. 2, as seen in the direction of an arrow III.

### DETAILED DESCRIPTION OF THE INVENTION

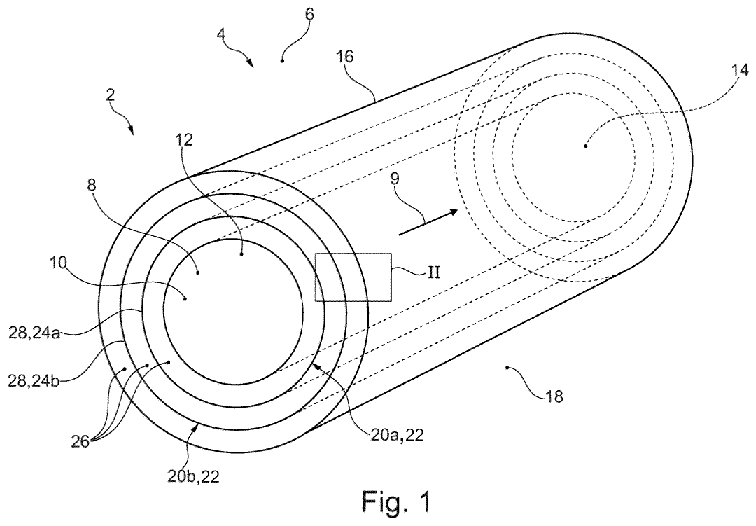

Referring now to the figures of the drawings in detail and first, particularly, to FIG. 1 thereof, there is seen a component 2, in this case an air-ducting component of an air-conditioning system 4 (not illustrated specifically) on a passenger aircraft 6. The component 2 is used to duct air 8 through the component 2 in the direction of an arrow 9. For this purpose, the component 2 has an interior space 10, which extends from an inlet 12 to an outlet 14 of the component 2. The interior space 10 serves for the actual ducting of the air 8 from the inlet 12 to the outlet 14 when the component 2 is in operation, i.e. is being flowed through by air 8.

The interior space 10 of the component is surrounded by a wall 16, wherein the inlet 12 and the outlet 14 are left free by the wall 16. The wall 16 therefore provides an airtight delimitation for the interior space 10 with respect to an exterior space 18 or surroundings of the component 2. In this case, “airtight” means that the following leakages L occur between the interior space 10 and the exterior space 18 at a corresponding differential pressure dp:

| Differential pressure dp [mbar] | Leakage L [I/min/m²] |
|---|---|
| 7 | 0.24 |
| 8 | 0.27 |
| 10 | 0.30 |
| 15 | 0.38 |
| 20 | 0.48 |
| 25 | 0.56 |
| 30 | 0.64 |
| 35 | 0.72 |
| 40 | 0.81 |

Thus, the component is significantly below the value of the maximum permissible leakage L of 1.96 l/min/m².

In this case, the relatively high airtightness is achieved as follows: in the present case, the wall 16 includes a first layer 20a and a second layer 20b of a prepreg material 22. In this case, the prepreg material 22 extends in the form of a surface, namely along a surface in the form of a right circular cylindrical shell. The size or thickness ratios of the wall 16 and the layers 20a, 20b are illustrated in a greatly distorted form in the figures for the sake of clarity. Each of the layers 20a, 20b or each of the prepreg materials 22 includes a fabric 24a, 24b extending correspondingly in the form of a surface, which is impregnated with a resin composition 26. In the example illustrated, the two prepreg materials 22 have already been fully processed to form the wall 16, i.e. they have been baked by using a thermal process conventional in the art to give an overall composite structure in the form of the wall 16, although this is not explained specifically herein.

The two fabrics 24a, 24b are therefore embedded, compressed or integrated into the resin composition 26 in its fully baked form. In the present case, both fabrics 24a, 24b are respective spread tow fabrics 28.

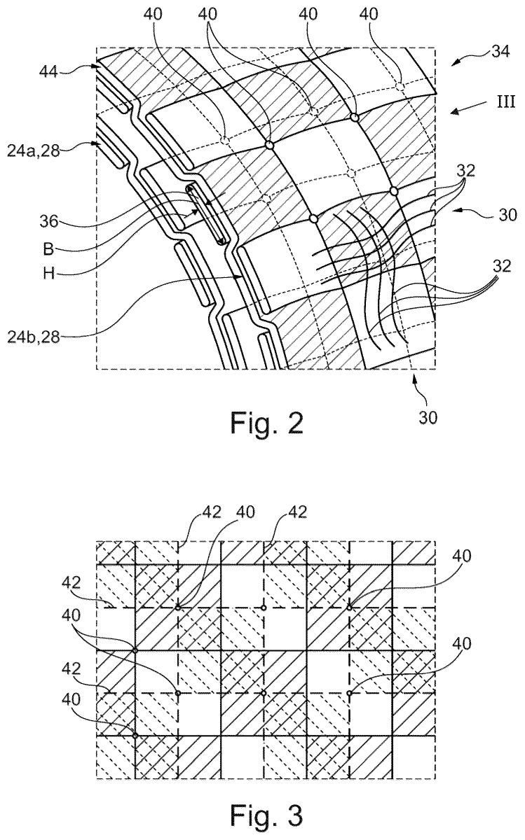

FIG. 2 shows a segment II of FIG. 1. In this case, the structure of the spread tow fabric 28 is illustrated diagrammatically. In a manner conventional in the art, each of the spread tow fabrics 28 includes respective spread tow tapes 30 made of fibers 32, which are indicated only symbolically herein. The tapes 30 are woven together in a weave 34. In the present case, the weave 34 is a linen weave.

In order to explain the weave, the respective tapes 30 running in the circumferential direction of the cylindrical shape of the component 2 are illustrated in hatched form in FIG. 2. The respective tapes running in the axial direction are illustrated without hatching.

In FIG. 2, a cross section 36 through a tape 30, transversely to the direction of longitudinal extent thereof, is indicated by hatching; in this case, by way of example, for an axially running tape of the tapes 30. The cross section 36 thus extends in the radial-circumferential plane. In this case, a ratio V of the width B thereof to the height H thereof is at least 100 to 1, more specifically 200 to 1 in the present case.

According to the linen weave in the form of the weave 34, the tapes 30 are in this case woven at right angles (circumferential direction to axial direction) to one another in each case. In this case, particularly the fabric 24a of the first layer 20a (but both fabrics 24a, 24b in the example) has gap points 40. The gap points 40 are located at the respective crossing points of lateral edges 42 of the tapes 30.

For clarification, FIG. 3 shows a plan view of the layer 20b or the fabric 24b in the direction of the arrow Il in FIG. 2. In this case, the underlying fabric 24a is illustrated in dashed lines. The lateral edges 42 of the tapes 30 of layer 20a, illustrated in dashed lines, thus cross one another, and there are corresponding gap points 40 there. This is because the tapes 30 do not rest seamlessly against one another herein, this being the inevitable result of the respective overlap of the tapes 30 due to the linen weave.

At these locations of the gap points 40 or “gaps,” there is the problem that—if there is only one layer 20a—it is possible for microchannels to form in the resin composition 26 due to the layer 20a or the “gaps” between the tapes 30, and those microchannels could extend substantially in the radial direction of the component 2, i.e. between the interior space 10 and the exterior space 18. That would have the effect that the microchannels would form connecting channels for the through flow of air 8, and that would severely reduce the airtightness of the wall 16.

For this reason, the layer 20b is disposed over layer 20a as follows. The layer 20b forms a covering 44 for the gap points 40: This is because each of the tapes 30 of the layer 20b covers one of the gap points 40 centrally, thus preventing the formation of the above-mentioned air channels. In this way, a maximum leak-tightness of the wall 16 can be achieved with just two layers 20a, 20b, in this case both spread tow fabrics 28. In the example, the covering 44 in the form of the layer 20b therefore jointly covers all the gap points 40 of the layer 20a. In the present example, this also applies in the opposite direction since the layer 20b also has gap points 40 that are diagonally offset in corresponding fashion with respect to the layer 20a, and these points are in turn covered or closed by the layer 20a as a covering 44. For the sake of clarity, however, this is not indicated again by reference signs in the figures.

In the example, the covering 44 is therefore likewise a prepreg material 22 in the form of a spread tow fabric 28. The covering 44 is also a further layer 20b of the prepreg material 22, that layer completely covering the first layer 20a.

In the case of a method for producing the component 2, the spread tow fabric 28 is thus integrated as the fabric 24a into the wall 16 in the first layer 20a, in this case, more specifically, being baked in in a manner conventional in the art, as explained above. Furthermore, all the gap points 40 in the layer 20a are covered by the covering 44, and the covering 44 in the form of the second layer 20b is also integrated into the wall 16, more specifically likewise being baked in.

In other words, the spread tow fabrics 28 are used in the component 2 and in the method described for the production thereof.

The following is a summary list of reference numerals and the corresponding structure used in the above description of the invention:
2 component
4 air-conditioning system
6 passenger aircraft
8 air
9 arrow
10 interior space
12 inlet
14 outlet
16 wall
18 exterior space
20a,b layer
22 prepreg material
24a,b fabric
26 resin composition
28 spread tow fabric
30 tape
32 fibers
34 weave
36 cross section
40 gap point
42 lateral edge
44 covering
L leakage
dp differential pressure
B width
H height
V ratio

1. A component for ducting air in an air-conditioning system on a passenger aircraft, the component comprising:
an interior space ducting the air during operation;
a wall airtightly delimiting said interior space relative to an exterior space surrounding the component;
said wall including at least a first layer of a prepreg material extending as a surface;
said prepreg material including a fabric extending as a surface, said fabric being impregnated with a resin composition;
said fabric, in at least said first layer, being a spread tow fabric including respective spread tow tapes made of fibers, said spread tow tapes being woven together in a weave.

2. The component according to claim 1, wherein at least one of said tapes has a ratio of a width to a height of at least 100 to 1 in cross section.

3. The component according to claim 1, wherein said tapes are woven at right angles to one another in said weave.

4. The component according to claim 3, wherein said weave is a linen weave.

5. The component according to claim 1, wherein said spread tow fabric has at least one gap point, and said wall includes at least one covering which covers said at least one gap point.

6. The component according to claim 5, wherein said at least one gap point is a crossing point of respective lateral edges of two mutually crossing tapes.

7. The component according to claim 5, wherein said covering jointly covers at least two gap points of said first layer.

8. The component according to claim 5, wherein said covering is a further prepreg material.

9. The component according to claim 8, wherein said further prepreg material includes a spread tow fabric.

10. The component according to claim 8, wherein said covering is a further layer of said further prepreg material, said further layer completely covering said first layer.

11. The component according to claim 1, wherein said wall has a leakage of air between said interior space and the exterior space of at most 3 l/min/m² at a pressure difference of 40 mbar.

12. The component according to claim 1, wherein said resin composition is a resin composition for a prepreg resin, including:
a phosphorus-modified epoxy resin,
a further epoxy resin component,
a curing agent, and
an imidazolium salt as an initiator, and
said resin composition includes 2 to 5 percent by weight of a reactive diluent to accelerate curing of said phosphorus-modified epoxy resin.

13. A method for producing the component according to claim 1, the method comprising integrating said spread tow fabric as said fabric into sad wall in at least said first layer.

14. The method according to claim 13, which further comprises:
providing said spread tow fabric with at least one gap point;
providing said wall with at least one covering integrated into said wall; and
covering said at least one gap point with said at least one covering.

15. A method, which comprises using the spread tow fabric in the component according to claim 1.

16. A method, which comprises using the spread tow fabric in the method according to claim 13.
